(19) United States
(12) Patent Application Publication
(10) Pub. No.: US 2026/0333370 A1
(43) Pub. Date: Oct. 22, 2026

(54) RADIO RESOURCE CONTROL (RRC) CONFIGURATION

(71) Applicant: Nokia Technologies Oy, Espoo (FI)

(72) Inventors: Tero HENTTONEN, Espoo (FI); Benoist Pierre SEBIRE, Tokyo (JP); Amaanat ALI, Espoo (FI)

(21) Appl. No.: 19/111,227

(22) PCT Filed: Aug. 16, 2023
(86) PCT No.: PCT/EP2023/072518

§ 371 Date: Mar. 12, 2025

(30) Foreign Application Priority Data
Sep. 14, 2022 (GB) 2213454.8

(51) Int. Cl. H04W 72/231; H04W 76/27

(52) U.S. Cl. CPC H04W 72/231; H04W 76/27

(57) ABSTRACT

Various example embodiments relate to apparatus and methods for Radio Resource Control (RRC) configuration in a wireless communication network. According to various, but not necessarily all, example embodiments there is provided a device configured to implement a Radio Resource Control RRC configuration to support radio communication between the device and another device in a wireless communication network, the device comprising: a Radio Resource Control kernel configured to implement: a radio processing unit, the radio processing unit being associated with a Radio Resource Control RRC configuration which enables radio communication between the device and the another device; and a further radio processing unit, the further radio processing unit being associated with a Radio Resource Control RRC configuration which supports radio communication between the device and the another device; wherein the radio processing unit and further radio processing unit are concurrently implementable by the Radio Resource Control kernel and wherein the Radio Resource configuration associated with each of the radio processing unit and further radio processing unit is retained by the Radio Resource Control kernel upon detection of one or more radio configuration event.

### TECHNOLOGICAL FIELD

Various example embodiments relate to apparatus and methods for Radio Resource Control (RRC) configuration in a wireless communication network.

### BACKGROUND

Communication between user equipment (UE) is supportable by the provision of a radio access communication network. Network access nodes, for example, base stations, are geographically distributed and support one or more cells of radio coverage and together form part of the network side of the communication network. User equipment in the area served or covered by a network access node are configured to establish communication with the radio access network via one or more radio link with the network access node.

User equipment and network nodes are configured to be able to establish and maintain functional radio links to support communication within the network. Establishment and maintenance of such radio links requires signalling between the user equipment and the network. Once such links are established, radio links can be used to support transfer of information between nodes of the network, for example, between user equipment, or between user equipment and the network side.

Methods and apparatus are needed to support radio communication within a radio access network.

### BRIEF SUMMARY

The scope of protection sought for various embodiments of the invention is set out in the independent claims. The examples and features, if any, described in this specification that do not fall under the scope of the independent claims are to be interpreted as examples useful for understanding various embodiments of the invention.

According to various, but not necessarily all, example embodiments there is provided a device configured to implement a Radio Resource Control RRC configuration to support radio communication between the device and another device in a wireless communication network, the device comprising: a Radio Resource Control kernel configured to implement: a radio processing unit, the radio processing unit being associated with a Radio Resource Control RRC configuration which enables radio communication between the device and the another device; and a further radio processing unit, the further radio processing unit being associated with a Radio Resource Control RRC configuration which supports radio communication between the device and the another device; wherein the radio processing unit and further radio processing unit are concurrently implementable by the Radio Resource Control kernel and wherein the Radio Resource configuration associated with each of the radio processing unit and further radio processing unit is retained by the Radio Resource Control kernel upon detection of one or more radio configuration event.

In some example embodiments, the device comprises user equipment. In some example embodiments, the another device comprises a network access node.

In some example embodiments, the radio processing unit is configured to support control plane communication between the device and the another device.

In some example embodiments, further radio processing unit is configured to support user plane communication between the device and the another device.

In some example embodiments, the RRC configuration comprises a plurality of radio parameters dictating or setting how the device should operate during radio communication in the wireless communication network.

In some example embodiments, the kernel is configured to implement a plurality of further radio processing units.

In some example embodiments, the plurality of further radio processing units are concurrently implementable to support parallel radio communication between the device and another device using at least two of the plurality of further radio processing units.

In some example embodiments, the plurality of further radio processing units are independently implementable to support parallel radio communication between the device and another device using at least two of the plurality of further radio processing units.

In some example embodiments, the RRC configuration associated with the radio processing unit and further radio processing unit is independently modifiable.

In some example embodiments, the device is configured to determine that a condition associated with use of the further radio processing unit is met and to commence radio resource control connection setup with the another device using the radio resource connection configuration associated with the further processing unit.

In some example embodiments, the one or more radio configuration event comprises the device exiting connected mode and entering idle mode.

In some example embodiments, the one or more radio configuration event comprises one or more of: radio link failure between the device and the another device; radio connection failure between the device and the another device; Radio Resource Control (RRC) state transition; handover; handover failure.

In some example embodiments, the one or more radio configuration event comprises an event experienced by a communication link supported by a further radio processing unit.

In some example embodiments, if a radio configuration event is detected, the device is configured to select a radio processing unit or further radio processing unit and initiate communication between the device and the another device using the associated Radio Resource Control RRC configuration which enables radio communication between the device and the another device.

In some example embodiments, if a radio configuration event is detected, the device is configured to select a radio processing unit or further radio processing unit for communication between the device and the another device and to communicate an indication of that selection to the another device.

According to various, but not necessarily all, example embodiments, there is provided a method of implementing a Radio Resource Control RRC configuration at a device to support radio communication between the device and another device in a wireless communication network, the method comprising: providing the device with a Radio Resource Control kernel and configuring the kernel to implement: a radio processing unit and a further radio processing unit, the radio processing unit and further radio processing unit being associated with a Radio Resource Control RRC configuration which enables radio communication between the device and the another device;
wherein the radio processing unit and further radio processing unit are concurrently implementable by the Radio Resource Control kernel and wherein the kernel is configured, upon detection of one or more radio configuration event, to retain the Radio Resource configuration associated with each of the radio processing unit and further radio processing unit.

In some example embodiments, the method is performed by user equipment. In some example embodiments, the device comprises user equipment. In some example embodiments, the another device comprises a network access node.

In some example embodiments, the method comprises configuring the radio processing unit to support control plane communication between the device and the another device.

In some example embodiments, the method comprises configuring the further radio processing unit to support user plane communication between the device and the another device.

In some example embodiments, the RRC configuration comprises a plurality of radio parameters dictating or setting how the device should operate during radio communication in the wireless communication network.

In some example embodiments, the method comprises configuring the kernel to implement a plurality of further radio processing units.

In some example embodiments, the method comprises implementing a plurality of further radio processing units are concurrently to support parallel radio communication between the device and another device using at least two of the plurality of further radio processing units.

In some example embodiments, the method comprises implementing a plurality of independent further radio processing units to support parallel radio communication between the device and another device using at least two of the plurality of further radio processing units.

In some example embodiments, the method comprises independently modifying the RRC configuration associated with the radio processing unit and further radio processing unit.

In some example embodiments, the method comprises determining that a condition associated with use of the further radio processing unit is met and commencing radio resource control connection setup with the another device using the radio resource connection configuration associated with the further processing unit.

In some example embodiments, the one or more radio configuration event comprises the device exiting connected mode and entering idle mode.

In some example embodiments, the one or more radio configuration event comprises one or more of: radio link failure between the device and the another device; radio connection failure between the device and the another device; Radio Resource Control (RRC) state transition; handover; handover failure.

In some example embodiments, the one or more radio configuration event comprises an event experienced by a communication link supported by a further radio processing unit.

In some example embodiments, if a radio configuration event is detected, the method comprises selecting a radio processing unit or further radio processing unit and initiating communication between the device and the another device using the associated Radio Resource Control RRC configuration which enables radio communication between the device and the another device.

In some example embodiments, if a radio configuration event is detected, the method comprises selecting a radio processing unit or further radio processing unit for communication between the device and the another device and to communicating an indication of that selection to the another device.

According to various, but not necessarily all, example embodiments of the invention there is provided a computer program product which, when executed by a processor on a device, is operable to control the device to perform an embodiment or further embodiment.

According to various, but not necessarily all, example embodiments there is provided a network device configured to implement a Radio Resource Control RRC configuration to support radio communication between a device and the network device in a wireless communication network, the network device comprising: Radio Resource Control circuitry configured to determine whether the device comprises a Radio Resource Control kernel configured to implement: a radio processing unit, the radio processing unit being associated with a Radio Resource Control RRC configuration which enables radio communication between the device and the network device; and a further radio processing unit, the further radio processing unit being associated with a Radio Resource Control RRC configuration which supports radio communication between the device and the network device; wherein the radio processing unit and further radio processing unit are concurrently implementable by the Radio Resource Control kernel and, if so, to store an indication of the Radio Resource configuration associated with each of the radio processing unit and further radio processing unit and retain the indication of the Radio Resource configuration associated with each of the radio processing unit and further radio processing unit upon detection of one or more radio configuration event.

In some example embodiments, the device comprises user equipment. In some example embodiments, the another device comprises a network access node.

In some example embodiments, the radio processing unit is configured to support control plane communication between the device and the another device.

In some example embodiments, further radio processing unit is configured to support user plane communication between the device and the another device.

In some example embodiments, the network device is configured to determine capability of the device by requesting an indication of kernel capability.

In some example embodiments, the indication of kernel capability comprises a kernel version number.

In some example embodiments, the network device is configured to transmit an indication of a default Radio Resource Control RRC configuration which enables radio communication between the device and the network device for the radio processing unit and the further radio processing unit to the device.

In some example embodiments, the network device is configured to store an indication of the default Radio Resource Control RRC configuration for the radio processing unit and further radio processing unit associated with the device.

In some example embodiments, the network device is configured to receive a connection request from the device, the connection request comprising an indication of the radio processing unit or further radio processing unit to be used to communication between the device and the network device.

In some example embodiments, the network device is configured to update a Radio Resource Control RRC configuration associated with the radio processing unit or further radio processing unit.

In some example embodiments, the network device is configured to update a Radio Resource Control RRC configuration associated with the radio processing unit or further radio processing unit in response to an indication of a radio link failure associated with the radio processing unit or further radio processing unit.

According to various, but not necessarily all, example embodiments there is provided a method of implementing Radio Resource Control RRC configuration at a network device to support radio communication between a device and the network device in a wireless communication network, the method comprising: determining whether the device comprises a Radio Resource Control kernel configured to implement: a radio processing unit, the radio processing unit being associated with a Radio Resource Control RRC configuration which enables radio communication between the device and the network device; and a further radio processing unit, the further radio processing unit being associated with a Radio Resource Control RRC configuration which supports radio communication between the device and the network device; wherein the radio processing unit and further radio processing unit are concurrently implementable by the Radio Resource Control kernel and, if so, storing an indication of the Radio Resource configuration associated with each of the radio processing unit and further radio processing unit; and retaining the indication of the Radio Resource configuration associated with each of the radio processing unit and further radio processing unit upon detection of one or more radio configuration event.

In some example embodiments, method is performed by a network node. In some example embodiments, the device comprises user equipment. In some example embodiments, the another device comprises a network access node.

In some example embodiments, the method comprises configuring the radio processing unit to support control plane communication between the device and the another device.

In some example embodiments, the method comprises configuring the further radio processing unit to support user plane communication between the device and the another device.

In some example embodiments, the method comprises configuring the network device to determine capability of the device by requesting an indication of kernel capability.

In some example embodiments, the indication of kernel capability comprises a kernel version number.

In some example embodiments, the method comprises configuring the network device to transmit an indication of a default Radio Resource Control RRC configuration which enables radio communication between the device and the network device for the radio processing unit and the further radio processing unit to the device.

In some example embodiments, the method comprises configuring the network device to store an indication of the default Radio Resource Control RRC configuration for the radio processing unit and further radio processing unit associated with the device.

In some example embodiments, the method comprises configuring the network device to receive a connection request from the device, the connection request comprising an indication of the radio processing unit or further radio processing unit to be used to communication between the device and the network device.

In some example embodiments, the method comprises configuring the network device to update a Radio Resource Control RRC configuration associated with the radio processing unit or further radio processing unit.

In some example embodiments, the method comprises configuring the network device to update a Radio Resource Control RRC configuration associated with the radio processing unit or further radio processing unit in response to an indication of a radio link failure associated with the radio processing unit or further radio processing unit.

According to various, but not necessarily all, example embodiments of the invention there is provided a computer program product which, when executed by a processor on a device, is operable to control the network device to perform an embodiment or further embodiment. According to various, but not necessarily all, example embodiments there is provided a device configured to implement Radio Resource Control RRC configuration to support radio communication between the device and another device in a wireless communication network, the device comprising: circuitry configured to provide the device with a Radio Resource Control kernel and configure the kernel to implement: a radio processing unit and a further radio processing unit, the radio processing unit and further radio processing unit being associated with a Radio Resource Control RRC configuration which enables radio communication between the device and the another device; wherein the radio processing unit and further radio processing unit are concurrently implementable by the Radio Resource Control kernel and wherein the kernel is configured, upon detection of one or more radio configuration event, to retain the Radio Resource configuration associated with each of the radio processing unit and further radio processing unit.

According to various, but not necessarily all, example embodiments there is provided an apparatus, comprising: at least one processor; and at least one memory including computer program code; the at least one memory and the computer program code configured to, with the at least one processor, cause the apparatus at least to implement Radio Resource Control RRC configuration to support radio communication between the device and another device in a wireless communication network; and providing the device with a Radio Resource Control kernel and configuring the kernel to implement: a radio processing unit and a further radio processing unit, the radio processing unit and further radio processing unit being associated with a Radio Resource Control RRC configuration which enables radio communication between the device and the another device; wherein the radio processing unit and further radio processing unit are concurrently implementable by the Radio Resource Control kernel and wherein the kernel is configured, upon detection of one or more radio configuration event, to retain the Radio Resource configuration associated with each of the radio processing unit and further radio processing unit.

According to various, but not necessarily all, example embodiments there is provided a network device configured to implement Radio Resource Control RRC configuration to support radio communication between a device and the network device in a wireless communication network, the network device comprising: circuitry configured to determine whether the device comprises a Radio Resource Control kernel configured to implement: a radio processing unit, the radio processing unit being associated with a Radio Resource Control RRC configuration which enables radio communication between the device and the network device; and a further radio processing unit, the further radio processing unit being associated with a Radio Resource Control RRC configuration which supports radio communication between the device and the network device; wherein the radio processing unit and further radio processing unit are concurrently implementable by the Radio Resource Control kernel and, if so, storing an indication of the Radio Resource configuration associated with each of the radio processing unit and further radio processing unit; and retaining the indication of the Radio Resource configuration associated with each of the radio processing unit and further radio processing unit upon detection of one or more radio configuration event.

According to various, but not necessarily all, example embodiments there is provided an apparatus, comprising: at least one processor; and at least one memory including computer program code; the at least one memory and the computer program code configured to, with the at least one processor, cause the apparatus at least to implement Radio Resource Control RRC configuration at a network device to support radio communication between a device and the network device in a wireless communication network, the apparatus being caused to at least implement: determining whether the device comprises a Radio Resource Control kernel configured to implement: a radio processing unit, the radio processing unit being associated with a Radio Resource Control RRC configuration which enables radio communication between the device and the network device; and a further radio processing unit, the further radio processing unit being associated with a Radio Resource Control RRC configuration which supports radio communication between the device and the network device; wherein the radio processing unit and further radio processing unit are concurrently implementable by the Radio Resource Control kernel and, if so, storing an indication of the Radio Resource configuration associated with each of the radio processing unit and further radio processing unit; and retaining the indication of the Radio Resource configuration associated with each of the radio processing unit and further radio processing unit upon detection of one or more radio configuration event.

Further particular and preferred aspects are set out in the accompanying independent and dependent claims. Features of the dependent claims may be combined with features of the independent claims as appropriate, and in combinations other than those explicitly set out in the claims.

Where an apparatus feature is described as being operable to provide a function, it will be appreciated that this includes an apparatus feature which provides that function or which is adapted or configured to provide that function.

### BRIEF DESCRIPTION

Some example embodiments will now be described with reference to the accompanying drawings in which:

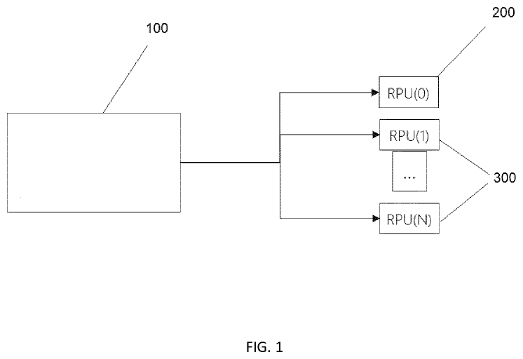

FIG. 1 illustrates an example embodiment of the subject matter described herein;

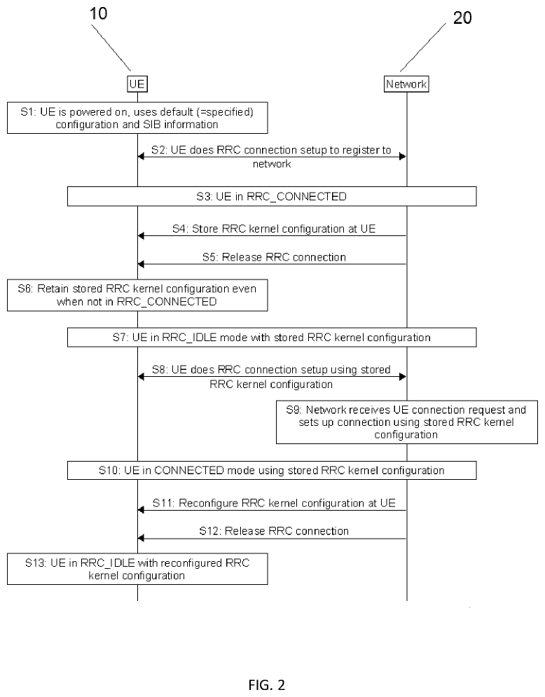

FIG. 2 to FIG. 5 illustrate schematically various signalling processes which may be used in example embodiments of the subject matter described herein;

FIG. 6 illustrates schematically a feature matrix which may be used to exchange information within a network about features supported by a device having capabilities in line with the subject matter described herein;

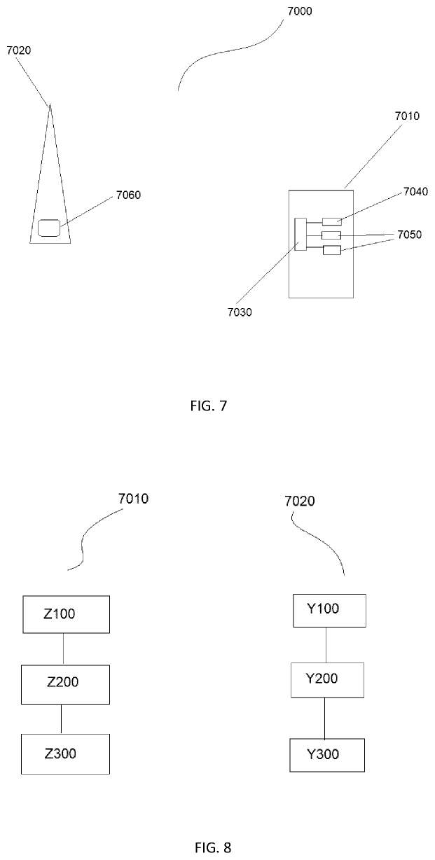

FIG. 7 shows apparatus in a communication system according to an example embodiment; and

FIG. 8 shows a flow diagram illustrating steps in methods performed at network nodes according to some example embodiments.

### DETAILED DESCRIPTION

Cellular wireless communication systems are built on top of protocols that control how the data is transmitted between user equipment within the system and nodes forming the operator network of the system. The protocols are often divided into user plane (UP) and control plane (CP). Typically, user plane protocols are directed towards transmission of data between the user equipment and the nodes forming the network. Control plane protocols are typically directed towards ensuring that the user plane is operational. That is, the CP is used for establishing UP, and it is the primary purpose of the CP to enable the function of the UP.

The primary protocol for the CP in UMTS/LTE/NR is the Radio Resource Control (RRC), whose specifications can be found in TS 25.331 (UMTS), TS 36.331 (LTE) and TS 38.331 (NR) respectively. The RRC specification defines the mechanisms for setting up a connection between user equipment (UE) and a network, establishing user plane and control plane protocol layers and reconfiguring the parameters of such protocol layers, as well as various procedures intended to keep both the UP and CP operational.

Establishing a connection for the first time between UE and a network can be based upon reception of a network's System Information (SI) messages at the UE, which are typically sent as System Information Blocks (SIBs) by the network. The SI transmitted within a network inform UE within the network of information relating to the network, including information on how to connect to the network. Establishing the connection to a network can also be based on UE capabilities, which a UE may indicate to the network when it first connects to it. Such an exchange of information allows for establishment of an appropriate connection, supporting operation of a UE based on UE capability.

The establishment of a connection requires a common knowledge of a “starting configuration” (which is sometimes also be called “default configuration”, but will be referred to as “fixed configuration” form here on), which determines the “default” configuration parameters that all UEs shall apply in absence of any other information (e.g. SI). This configuration is static, i.e. cannot be changed since it is specified in the RRC specification. When a UE starts a connection for the first time, the network knows the UE configuration is based on the fixed configuration and can use that knowledge to only signal values that are different from the fixed configuration when providing the RRC configuration. This is called delta signalling, wherein network minimize signalling overhead by only providing the values that differ from the UE stored configuration.

In UMTS, use of various fixed configurations is possible as detailed in clause 13.7 TS 25.331. These can be referred to according to an identity number, but all of them are still fixed in the specification TS 25.331. This provision of multiple fixed configurations had the potential to offer more adaptability and reduce signalling overhead, but caused problems as some specification versions had errors that prevented use of such configurations in practice. To avoid such errors, LTE adopted a single, very “lean” fixed configuration as detailed in clause 9 of TS 36.331, and NR adopted very similar approach to the lean version of LTE as set out in clause 9 of TS 38.331.

In a network that employs Long Term Evolution, LTE, as defined by the Third Generation Partnership Project, 3GPP, a user equipment may operate in a CONNECTED mode, INACTIVE mode or IDLE mode. In the CONNECTED mode the user equipment exchanges data with the network and when it is in IDLE mode the user equipment monitors various information and messages transmitted from the network. In INACTIVE mode the user performs as in IDLE mode, but stores a configuration provided by the network. If CONNECTED, a protocol called Radio Resource Control, RRC, is employed. Whenever user equipment enters CONNECTED mode and becomes connected to the network to perform a radio communication, the network operates to transmit control message(s) to the user equipment (control plane communication). The control plane interaction contains an RRC configuration to be used by the user equipment to establish and retain communication with the network. The RRC configuration comprises a plurality of radio parameters that the user equipment is instructed to apply in the radio communication with the network. When the user equipment is in a CONNECTED mode, an RRC configuration is maintained with the network. Some of the RRC configuration may comprise static RRC related radio parameters, applicable to most user equipment operating within the network and some parameters may relate to a particular user equipment. Such dedicated RRC configuration parameters can be sent to a specific user equipment, for example, at RRC reconfiguration, or at RRC connection setup when the user equipment switches from IDLE to CONNECTED mode.

Such configuration messages can be quite large containing a considerable amount of information elements which consume radio resources when communicated to user equipment. This can also result in delay since sending the configuration to the user equipment may require use of multiple messages by the network, all of which may need to be received by the UE before the entirety of the configuration can be applied.

As a result, the capacity and performance of a network in relation to pure data communication (in the user plane) may suffer greatly due to the need to communicate appropriate RRC configurations to user equipment (in the control plane) which can require use of considerable bandwidth. User plane operation is inherently tied to RRC configuration and RRC configuration sets all radio connection parameters, including those of the user plane. The configuration is one monolithic “chunk”, contains everything and validated all at once”, i.e. the entire configuration has to be applied at once when received by the UE. If any part has errors, typically the entire configuration fails. This means that as more features are introduced for every 3GPP release, the RRC configuration typically increases in size. This makes the scalability of RRC worse with every added feature. Implementing RRC configuration in known ways does not offer real scalability or flexibility. For example, the single block configuration does not support any dynamic control of the amount of resource used to support power saving operation. It can therefore be understood that implementation of a standard monolithic RRC configuration can limit various aspects of network operation, for example, causing bottlenecks for connection robustness and difficulties with user plane scalability.

Furthermore, RRC failure mechanisms in cellular systems are rudimentary. When most RRC errors occur, a UE considers radio link failure (RLF) to occur and discards large parts of its RRC configuration, falling partly back to the “fixed” RRC configuration defined in specification. To resume communication with the network, the UE triggers a re-establishment procedure. That procedure may require the network to signal the entire UE configuration again, using only the (default) fixed configuration as the reference point, which can require large RRC message to be sent. Invoking the re-establishment procedure takes time and signalling resource. Since RRC errors also occur every now and then in every wireless communication network, there is a systemic inefficiency in all UMTS/E-UTRA/NR systems (ie whether 3G/4G/5G).

Arrangements and methodologies described herein seek to provide alternative ways to support radio communication within a radio access network. Before discussing the example embodiments in any more detail, first an overview will be provided.

In particular, arrangements provide a user device configured to implement a Radio Resource Control RRC configuration to support radio communication between the device and another device in a wireless communication network. The user device comprises: a Radio Resource Control kernel configured to implement a radio processing unit. The radio processing unit is associated with a Radio Resource Control RRC configuration which enables radio communication between the device and the another device. The device comprises and a further radio processing unit, the further radio processing unit being associated with a Radio Resource Control RRC configuration which supports radio communication between the device and the another device. The radio processing unit and further radio processing unit are concurrently implementable by the Radio Resource Control kernel. The Radio Resource configuration associated with each of the radio processing unit and further radio processing unit is retained by the Radio Resource Control kernel upon detection of one or more radio configuration event.

Similarly, at the network side, arrangements provide a network device configured to implement a Radio Resource Control RRC configuration to support radio communication between a user device and the network device in a wireless communication network. The network device comprising Radio Resource Control circuitry configured to determine whether the device comprises a Radio Resource Control kernel as set out above. If the network device determines that the device has such capability, the network device operates to store an indication of the Radio Resource configuration associated with each of the radio processing unit and further radio processing unit and retain the indication of the Radio Resource configuration associated with each of the radio processing unit and further radio processing unit upon detection of one or more radio configuration event.

Arrangements provide a scalable protocol architecture in which a UE supports an “RRC Kernel” (RK) entity and one or more user plane “Radio Processing Units” (RPU) entity. The RK entity is configured to handle control plane operation whilst the RPU(s) are configured to handle user plane operation. Since RK still requires user plane, an RPU may also be configured for RK operation.

According to arrangements, the RK entity configures the RPU(s), and the RK entity holds the RPU configurations so that they are stored by a UE even when the RPUs are not configured for operation in an RRC_CONNECTED mode. The RK may also configure one or more RPU for operation in RRC_INACTIVE or RRC_IDLE mode.

In CONNECTED, at least one RPU is always configured to allow sending messages related to the RK operation.

If an RPU fails, the UE can fall back to use of a stored RK configuration for an RPU, and can indicate that it is using the RK configuration for the RPU to the network, thus ensuring that both UE and network are aware that the indicated RPU uses “fallback” RK configuration. If all RPUs fail, UE falls back to the RK configuration for CP only and will attempt to re-establish connection using that.

Arrangements support scalable operation by virtue of provision of more than one RPU. Arrangements are such that user plane operation can be scaled by adding additional RPUs to a configuration.

Furthermore, rather than a need to start from scratch in the event of a link failure, a mechanism where a UE and network according to arrangements have the ability to support an “always-on” configuration is considered, which supports fallback to a basic RPU operation using stored RK configuration if an error causes a configuration of RPU(s) to fail or be discarded.

Whilst arrangements may be such that RPUs can rely on the same radio resources, arrangements may be such that overlap between the protocols, actual hardware and the configuration of each RPU can be minimised to ensure that RPUs can be added and removed without disrupting other RPUs. Adopting such a “fault-tolerant” implementation of arrangements permits a fine granularity which can be of use in isolating faults. In other words, failure of an RPU can be localized and may not catastrophically impact the other RPU(s).

FIG. 1 illustrates schematically an example embodiment of the subject matter described herein. User equipment in a wireless communication network according to an arrangement is provided with an RRC kernel (RK) entity 100. The RRC kernel supports one 200 or more 300 radio processing unit (RPU), each of which maps to an RRC configuration which supports communication or establishment of communication with a network node of the wireless communication network.

The operation of the RK is described below in more detail:

According to a general arrangement, a UE may have one “RRC Kernel” 100 configuration. When first registering or establishing communication with a network the UE starts from a fixed radio configuration, in line with the fixed radio configuration set by standards currently. After initial registration, the network has provided the UE with one or more RRC configuration(s) that are stored, even in the event of RRC connection failure, for use by the UE, those RRC configuration(s), each represented by a Radio Processing Unit (RPU) 300 and are initialized by the RRC Kernel 100 running a Radio Processing Unit 200. Some arrangements provide that the RK is stand-alone and is attached to UP RPU(s). Other arrangements provide a separate RPU for CP, and additional UP RPU(s).

The RRC configuration(s) stored by the UE include at least one RPU configuration which may be used in several RRC states. The RRC configuration(s) associated with each RPU may optionally comprise an indication of configuration of one or more radio bearers; a configuration of the radio protocols (for example, RLC mode, SN length) and similar configuration information. The configuration information associated with each RPU 300 may be stored and remain available for selection while the UE is registered to the network, including when a UE changes RRC state.

According to some arrangements, the RK 100 is always associated with at least one kernel RPU 200 known as RPU(0) and is always operational via that associated RPU 200. The RK 100 operates such that in the event of RRC failure, for example, Radio Link Failure (RLF) or Hand Over Failure (HOF), it is configured to fall back to one of the stored configurations associated with an RPU 200 or RPU 300. In other words, the RK stores the RRC configuration(s); the RPUs allow UP or CP transmissions; and if an RPU fails, the UE is configured to fall back to RK configuration for that RPU. The fallback configuration may include the kernel RPU (RPU(0)) 200. Arrangements are such that the RK can hold or fall back to an RRC configuration saved by the UE rather than invoke a need to flush a current configuration and commence an RRC re-establishment procedure. Such an approach can support overall network robustness.

In other words, a UE having an RK 100 with associated RPUs 200, 300 is configured to retain at least one RRC configuration after radio link failure and fall back to that RRC configuration. According to some arrangements, a UE comprising a RK 100 with associated functionality can be configured to indicate to the network which of the possible retained RRC configuration(s) have been selected for use. It will be appreciated that the indication can take various forms, for example: an RK version number; a specific identifier of a stored RK configuration; a specific message or message type related to an RK. As appropriate, the network can then use the identified stored RK configuration(s) as required to implement appropriate RRC signalling, such as delta signalling based on the stored RK configuration.

According to some implementations, an RK may have an associated version number. The RK version number may be indicative of specified capabilities supported by the RK. The version number may, for example, be indicative of a default number of RPUs supported by the RK. The version number may be indicative of an RRC configuration supported by each RPU associated with the RK.

According to some implementations, each RPU supported by an RK is configured by the RK. The RK configures the RPU to handle user plane transmissions, including encapsulation of control plane messaging, towards UE. That operation is similar to, for example, NR RRC configuration of protocol layers (e.g. SDAP, PDCP, RLC, MAC, PHY).

According to implementations, while a UE is in an RRC_CONNECTED state, the UE will always have at least one RPU configured by the RK for operation. When a UE falls back to RRC_IDLE or RRC_INACTIVE, the RPU configured for use in an RRC_CONNECTED state can be released and the RPU may fall back using the RK to set a stored or default RPU configuration.

According to some implementations, an RPU may be configured to handle one or more serving cells. According to some implementations, an RPU may be configured to handle one or more configured features (for example, one or more MIMO layers).

Implementation may be such that a UE always has at least one RK and at least one RPU, and the RK may have at least one stored RPU configuration.

The schematic of FIG. 1 assumes that the same RPU, RPU(0) 200 is always associated with RK 100. However, according to an alternative implementation, the RPU used in support of RK operation, supporting the kernel configuration or an updated version of the kernel configuration, may be changed. Such a change may be, for example, implemented whilst a UE is operating in an RRC_CONNECTED state, and may be changed, for instance, by configuration. As a result, it will be appreciated that the RPU which is used for transmitting control plane messages could, depending upon implementation choices, be switched freely.

Generally arrangements in accordance with this disclosure are such that an apparatus, for example, UE, can be provided with a Radio Kernel (RK) entity. That RK may be configured to receive and store one or more Radio Processing Unit (RPU) configuration. According to arrangements, a Radio Processing Unit (RPU) configuration supported by an RRC Kernel comprises a user plane configuration allowing exchange of data between user equipment and a network node. In other words, each RPU is a user plane configuration which supports transmission of data to and/or reception of data from, a network node and user equipment in a wireless communication network.

The RK and associated RPU configuration(s) at a UE may be stored even when a configured radio protocol event occurs. If such an event occurs, arrangements may be such that the apparatus may select one of the stored RPU configurations and send an indication to a second apparatus, for example, a network node, indicating which of the stored RPU configurations has been applied. The configured radio protocol event according to which the RK and associated RPU(s) may provide particular utility to a UE and network may comprise one or more of: handover; handover failure; RRC state transition; radio link failure, or radio connection failure.

Consider a possible representation below in which a UE within a network supports one RK having 8 associated RPUs as set out in the table below:

| | | | | | Social | |
|---|---|---|---|---|---|---|
| Case | Factory | IDLE | SDT | BROWSING | Media | XR |
| RK | V1.0 | V1.2 | V1.2 | | | |
| RPU0 | — | Idle | Standby | Connected | Connected | Connected |
| RPU1 | — | — | — | Standby | Standby | Connected |
| RPU2 | — | — | — | | Standby | Connected |
| RPU3 | — | — | — | | Standby | Connected |
| RPU4 | — | — | — | | | Standby |
| RPU5 | — | — | — | | | Standby |
| RPU6 | — | — | — | | | Standby |
| RPU7 | — | — | — | | | Standby |

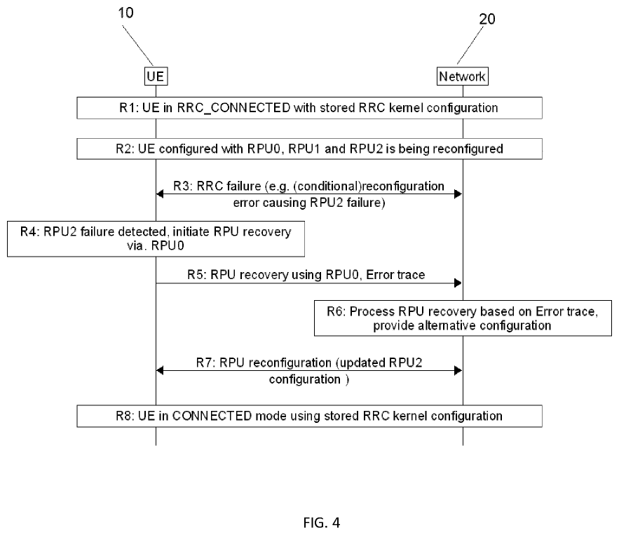

Upon production at a factory, a UE device may be configured to support V1.0 of an RRC Kernel and 8 associated Radio Processing Units. Once attached to a communication network, a default kernel configuration can be changed to V1.2 and RPU0 can be configured to handle both idle and small data transmissions, as well as “default” transmissions that are used for recovering from error cases (see, for example, the signalling of FIG. 4). For services requiring higher throughput, RPU0 may be switched to a CONNECTED mode and additional RPUs can be activated for possible data transmission. In the example set out in the table above, an RPU ready for transmission but not transmitting yet is depicted as being in STANDBY while an RPU actively involved in data transmissions are shown as being CONNECTED. The higher the maximum bit rate required in support of user plane operation, the higher the number of total RPUs in use. The ratio between RPUs being in CONNECTED and RPUs being in STANDBY may be altered by a network in dependence upon a desired balance between power saving and latency since an RPU in Standby mode increases power saving but also increases latency when going to CONNECTED mode. In accordance with the arrangements and methods described in more detail, provided any of the configured RPU remain in either Standby or Connected mode, full radio link failure need not be triggered by the UE, and some communication between a UE and the network may be maintained.

FIGS. 2 to 5 are signalling diagrams illustrating schematically various methods to implement arrangements.

FIG. 2 is a signalling diagram showing main steps of one possible implementation to initialise and configure an RRC Kernel and associated Radio Processing Unit(s) provided at user equipment of a wireless communication network for the first time.

FIG. 2 shows initiation signalling according to an arrangement between user equipment 10 and a network 20.
S1: The UE 10 is powered on and operates to use a fixed configuration as set in the standards, together with System Information Block (SIB) information.
S2: Based on the information and fixed configuration determined in S1, the UE 10 and network 20 exchange information over a radio link. The UE and network perform an RRC connection setup procedure to register to the network.
S3: The UE 10 has established a communication link in the RRC_CONNECTED state with the network 20.
S4: Having established an RRC_CONNECTED link with the UE 10, the network 20 operates to transmit information to the UE 10, enabling the UE to establish and store an RRC kernel configuration.
S5: The network may release the RRC connection.
S6: The UE 10 is configured to retain the stored RRC kernel configuration set by the network 20 even when not in the RRC_CONNECTED state.
S7: The UE 10 may be in RRC_IDLE mode, using a stored RRC kernel configuration.
S8: If the UE requires to transition to a more connected state to operate, the UE 10 according to arrangements is configured to perform RRC connection setup using the stored RRC kernel configuration.
S9: The network 20 received the UE connection request and sets up a connection using the stored RRC kernel configuration associated with the UE 10.
S10: The UE 10 then operates in a connected mode using the stored RRC kernel configuration.

As a result of those step S1 to S10, a communication link can be established between the UE 10 and the network 20 without resorting to a need to fall back to the fixed configuration set in the standard, in combination ith information obtained from the System Information Block (as required at initialisation in steps S1 to S3).
S11: The network may adapt or reconfigure the RRC kernel configuration associated with UE 10. If so, both the network 20 and the UE 10 may operate to store that reconfiguration. The reconfiguration may occur whilst the UE 10 is in a connected mode.
S12: The RRC connection between the UE 10 and the network 20 may be released.
S13: The UE 10 may be in RRC_IDLE mode, using a stored updated RRC kernel configuration.

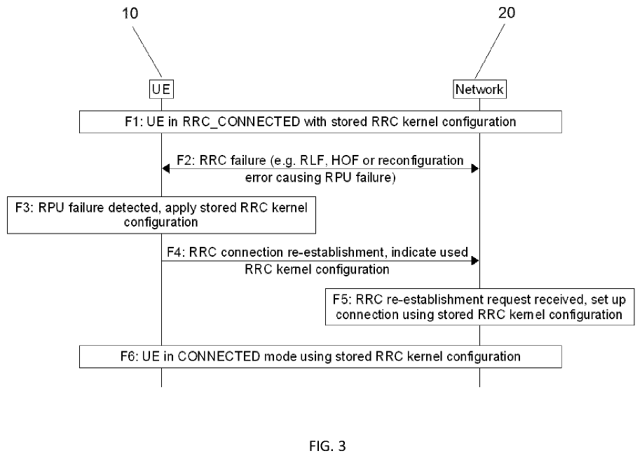

FIG. 3 is a signalling diagram showing main steps of one possible implementation in which a UE 10 having an RRC Kernel and associated Radio Processing Unit(s) configured, for example, in accordance with FIG. 2, experiences radio link failure.

FIG. 3 shows signalling according to an arrangement between user equipment 10 and a network 20 in the event of RRC connection failure.
F1: UE 10 has established a communication link with network 20 and is operating, using one or more RPUs of the stored RRC kernel configuration in an RRC_CONNECTED state.
F2: RRC failure occurs, for example, a Radio Link Failure (RLF), HandOver Failure (HOF) or reconfiguration error, causing one or more RPU failure.
F3: The UE detects RPU failure and, rather than initialise radio link reestablishment from first principles (steps S1 to S3 of FIG. 2), is operable to apply a stored RRC kernel configuration.
F4: The UE 10 operates to initialise RRC connection reestablishment, based on a stored RRC kernel configuration. As part of the re-establishment procedure, the UE 10 is configured to indicate the RRC kernel configuration used to the network 20.
F5: The network 20 receives the RRC re-establishment request from the UE 10, notes the indication of RRC kernel configuration used and the stored RRC kernel configuration associated with UE 10, and operates to set up a connection using the appropriate stored RRC kernel configuration.
F6: The UE 10 can then communicate with the network 20 in a connected mode, using the stored RRC kernel configuration.

FIG. 4 is a signalling diagram showing main steps of one possible implementation in which a UE 10 having an RRC Kernel and associated Radio Processing Unit(s) configured, for example, in accordance with FIG. 2, experiences RPU failure.

FIG. 4 shows signalling according to an arrangement between user equipment 10 and a network 20 in the event of RPU connection failure.
R1: UE 10 has established a communication link with network 20 and is operating, using one or more RPUs of the stored RRC kernel configuration in an RRC_CONNECTED state.
R2: UE 10 is configured with an RRC kernel having an associated Radio Processing Unit RPU0, together with two further RPUs, RPU1 and RPU2. At step R2, RPU is being reconfigured by the network 20 and UE 10.
R3: RRC failure occurs, for example a conditional reconfiguration error causing RPU2 failure.
R4: UE 10 detects RPU2 failure and is operable to initiate RPU recovery via RPU0.
R5: The UE 10 initiates RPU recovery using RPU0 and sends an error trace indication to the network 20.
R6: The network can process RPU recovery based on the information provided by UE 10 and, in the example illustrated, the network is configured to provide an alternative RPU2 configuration to UE 10.
R7: The network 20 sends an RPU reconfiguration to UE 10. The reconfiguration provided relates to an updated RPU2 configuration.
R8: The UE 10 operates is connected mode using the stored, and updated, RRC kernel configuration.

In other words, according to some implementations of arrangements, the failure of RPU2 may not lead to complete failure of user plane operation. The UE 10 is configured to continue to operate using RPU0 and RPU1, even when RPU2 failed. The continuation of operation in a connected mode using RPU0 and RPU1 supported the adaptation and ultimately reintroduction of operation of RPU2.

The reconfiguration failure of a RPU shown in FIG. 4 (for example, conditional RRC reconfiguration execution error during activation of stored configuration or normal reconfiguration error) does not necessitate a RRC re-establishment procedure by UE 10 and implementations support methods in which UE 10 can report the failure to the network 20. The network 20 supports operation in which a restart of the failed RPU is possible by providing an updated (re) configuration of that RPU against the one the network 20 and UE 10 both know is stored. In FIG. 4 the UE 10 and network 20 are configured to use RPU0 (fallback) to recover RPU2 from the error it experienced.

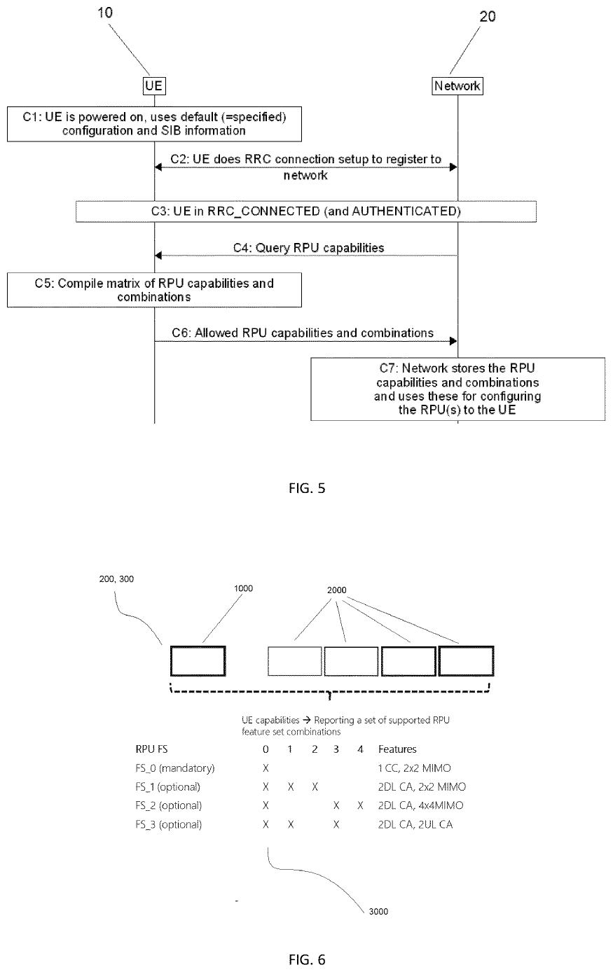

FIG. 5 is a signalling diagram showing main steps of one possible implementation in which a UE 10 having an RRC Kernel capability and associated Radio Processing Unit(s) capability can indicate that capability to a network.

FIG. 5 shows signalling according to an arrangement between user equipment 10 and a network 20 in support of RRC kernel and RPU capability discovery.
C1: The UE 10 is powered on and operates to use a fixed configuration as set in the standards, together with System Information Block (SIB) information.
C2: Based on the information and fixed configuration determined in S1, the UE 10 and network 20 exchange information over a radio link. The UE and network perform an RRC connection setup procedure to register to the network.
C3: The UE 10 has established a communication link in the RRC_CONNECTED state with the network 20.
C4: The network 20 can query UE 10 to provide information regarding RK and RPU capabilities.
C5: The UE 10 compiles or accesses a matrix of RPU capabilities and combinations supportable by the UE.
C6: The UE 10 reports the allowed RPU capabilities and combinations to the network 20.
C7: The network 20 is configured to store the RPU capabilities and combinations associated with UE 10 and uses that information when configuring RPU(s) in relation to that UE 10.

FIG. 5 illustrates the signalling procedure of a network 20 when retrieving an indication of UE 10 capabilities associated with RPU(s) of that UE. The UE 10 may advertise such RPU capabilities based on a received filter which allows a UE to prune reported capabilities in dependence upon the filter. By way of example, a UE 10 may report RPU capabilities a matrix format which allows reporting of capabilities on a per RPU basis in a first dimension and supports reporting of allowed combinations of RPU(s) using a second dimension.

FIG. 6 illustrates schematically one possible construction of a feature matrix for reporting RPU 200, 300 capability to a network. In order to function as an RPU there are mandatory RPU capabilities 1000. In addition to that capability, each RPU may have extended RPU capabilities 2000. Those capabilities may be indicated, together with allowable combinations of feature sets across RPUs, in the matrix 3000. The capabilities 2000 supported by RPUs 200, 300 may include, for example, MIMO capability, Carrier Aggregation level in down or uplink, and similar.

FIG. 7 shows apparatus in a communication system according to an example embodiment. In particular FIG. 7 illustrates a wireless communication network 7000 in which a network node 7020 is configured to communicate with user equipment 7010. The user equipment and network are configured to implement a Radio Resource Control RRC configuration to support radio communication between the user equipment 7010 and network node in a wireless communication network. User equipment 7010 in accordance with one example embodiment may comprise: a Radio Resource Control kernel 7030 configured to implement: a radio processing unit 7040, the radio processing unit being associated with a Radio Resource Control RRC configuration which enables radio communication between the user equipment and the another network access node; and a further radio processing unit 7050, the further radio processing unit being associated with a Radio Resource Control RRC configuration which supports radio communication between the user equipment and the network node. In the example shown, the radio processing unit 7040 and further radio processing unit 7050 are concurrently implementable by the Radio Resource Control kernel 7030 and the Radio Resource configuration associated with each of the radio processing unit 7040 and further radio processing unit 7050 is retained by the Radio Resource Control kernel upon detection of one or more radio configuration event.

The network access node 7020, for example, a base station, may comprise Radio Resource Control circuitry 7060 configured to determine whether the user equipment 7010 has Radio Resource Control capability as described above and, if so, the circuitry 7060 may be configured to store an indication of the Radio Resource configuration associated with each of the radio processing unit 7040 and further radio processing unit 7050 and retain the indication of the Radio Resource configuration associated with each of the radio processing unit 7040 and further radio processing unit 7050 upon detection of one or more radio configuration event.

FIG. 8 shows a flow diagram illustrating steps in methods performed at network nodes according to the example embodiment shown in FIG. 7.

In particular, user equipment 7010 may be configured to perform the steps of:
Z100: Providing a Radio Resource Control kernel configured to implement: a radio processing unit, the radio processing unit being associated with a Radio Resource Control RRC configuration which enables radio communication between the user equipment and the another network access node; and a further radio processing unit, the further radio processing unit being associated with a Radio Resource Control RRC configuration which supports radio communication between the user equipment and the network node;
Z200: Concurrently implementing the radio processing unit and further radio processing unit; and
Z300: Retaining or storing the Radio Resource configuration associated with each of the radio processing unit and further radio processing unit upon detection of one or more radio configuration event.

Similarly, base station 7020 may be configured to perform the steps of:
Y100: Determining whether the user equipment 7010 has Radio Resource Control capability as described above and, if so,
Y200: Storing an indication of the Radio Resource configuration associated with each of the radio processing unit and further radio processing unit; and
Y300: Retaining the indication of the Radio Resource configuration associated with each of the radio processing unit and further radio processing unit upon detection of one or more radio configuration event.

A person of skill in the art would readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods. The term non-transitory as used herein, is a limitation of the medium itself (i.e., tangible, not a signal) as opposed to a limitation on data storage persistency (e.g. RAM vs ROM).

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1-25. (canceled)

26. A device configured to implement a Radio Resource Control RRC configuration to support radio communication between the device and another device in a wireless communication network, the device comprising:
a Radio Resource Control kernel configured to implement:
a radio processing unit, the radio processing unit being associated with a Radio Resource Control RRC configuration which enables radio communication between the device and the another device; and
a further radio processing unit, the further radio processing unit being associated with a Radio Resource Control RRC configuration which supports radio communication between the device and the another device;
wherein the radio processing unit and further radio processing unit are concurrently implementable by the Radio Resource Control kernel and wherein the Radio Resource configuration associated with each of the radio processing unit and further radio processing unit is retained by the Radio Resource Control kernel upon detection of one or more radio configuration event.

27. A device according to claim 26, wherein the device comprises user equipment; and wherein the another device comprises a network access node.

28. A device according to claim 26, wherein the radio processing unit is configured to support control plane communication between the device and the another device.

29. A device according to claim 26, wherein the further radio processing unit is configured to support user plane communication between the device and the another device.

30. A device according to claim 26, wherein the RRC configuration comprises a plurality of radio parameters dictating how the device should operate during radio communication in the wireless communication network.

31. A device according to claim 26, wherein the kernel is configured to implement a plurality of further radio processing units.

32. A device according to claim 31, wherein the plurality of further radio processing units are concurrently implementable to support parallel radio communication between the device and another device using at least two of the plurality of further radio processing units.

33. A device according to claim 26, wherein the plurality of further radio processing units are independently implementable to support parallel radio communication between the device and another device using at least two of the plurality of further radio processing units.

34. A device according to claim 26, wherein the RRC configuration associated with the radio processing unit and further radio processing unit is independently modifiable.

35. A device according to claim 26, wherein the device is configured to determine that a condition associated with use of the further radio processing unit is met and to commence radio resource control connection setup with the another device using the radio resource connection configuration associated with the further processing unit.

36. A device according to claim 26, wherein the one or more radio configuration event comprises the device exiting connected mode and entering idle mode.

37. A device according to claim 26, wherein the one or more radio configuration event comprises one or more of: radio link failure between the device and the another device; radio connection failure between the device and the another device; Radio Resource Control (RRC) state transition; handover; handover failure.

38. A device according to claim 26, wherein the one or more radio configuration event comprises an event experienced by a communication link supported by a further radio processing unit.

39. A device according to claim 26, wherein, if a radio configuration event is detected, the device is configured to select a radio processing unit or further radio processing unit and initiate communication between the device and the another device using the associated Radio Resource Control RRC configuration which enables radio communication between the device and the another device.

40. A device according to claim 26, wherein, if a radio configuration event is detected, the device is configured to select a radio processing unit or further radio processing unit for communication between the device and the another device and to communicate an indication of that selection to the another device.

41. A network device configured to implement a Radio Resource Control RRC configuration to support radio communication between a device and the network device in a wireless communication network, the network device comprising:
Radio Resource Control circuitry configured to determine whether the device comprises a Radio Resource Control kernel configured to implement:
a radio processing unit, the radio processing unit being associated with a Radio Resource Control RRC configuration which enables radio communication between the device and the network device; and
a further radio processing unit, the further radio processing unit being associated with a Radio Resource Control RRC configuration which supports radio communication between the device and the network device;
wherein the radio processing unit and further radio processing unit are concurrently implementable by the Radio Resource Control kernel and, if so,
to store an indication of the Radio Resource configuration associated with each of the radio processing unit and further radio processing unit and retain the indication of the Radio Resource configuration associated with each of the radio processing unit and further radio processing unit upon detection of one or more radio configuration event.

42. A network device according to claim 41, wherein the network device is configured to determine capability of the device by requesting an indication of kernel capability.

43. A network device according to claim 41, wherein the network device is configured to transmit an indication of a default Radio Resource Control RRC configuration which enables radio communication between the device and the network device for the radio processing unit and the further radio processing unit to the device.

44. A network device according to claim 41, wherein the network device is configured to store an indication of a default Radio Resource Control RRC configuration for the radio processing unit and further radio processing unit associated with the device.

45. A network device according to claim 41, wherein the network device is configured to receive a connection request from the device, the connection request comprising an indication of the radio processing unit or further radio processing unit to be used to communication between the device and the network device.

46. A network device according to claim 41, wherein the network device is configured to update a Radio Resource Control RRC configuration associated with the radio processing unit or further radio processing unit.

47. A network device according to claim 41, wherein the network device is configured to update a Radio Resource Control RRC configuration associated with the radio processing unit or further radio processing unit in response to an indication of a radio link failure associated with the radio processing unit or further radio processing unit.
